(19) United States
(12) Patent Application Publication
(10) Pub. No.: US 2008/0113322 A1
(43) Pub. Date: May 15, 2008

(54) Kit And Method For Assessing, Labeling, Understanding And Directing Thoughts

(75) Inventor: Rachel Robb Avery, Portland, ME (US)

Correspondence Address: CHRIS A. CASEIRO, VERRILL DANA, LLP, ONE PORTLAND SQUARE, PORTLAND, ME, 04112-0586, US

(73) Assignee: Smart Thot, LLC, Falmouth, ME (US)

(21) Appl. No.: 11/559,493

(22) Filed: Nov. 14, 2006

(51) Int. Cl. G09B 19/00

(52) U.S. Cl. 434/236

(57) ABSTRACT

A kit and method for teaching a child positive thinking skills, including awareness of self talk, recognizing self-defeating or irrational thinking, using positive and coping self talk, thought-stopping negative thoughts, replacing self-defeating and irrational thoughts with positive or coping thoughts, regularly using positive thinking skills and self thought check ups. The kit and method further are used to teach the child positive thinking skills associated with positive self esteem and feelings of efficacy, as well as increased emotional resilience and stress resistance. The kit includes one or more thought assessment and thought remedying devices for achieving those goals by carrying out the method. The kit may further include other supporting devices which may be used to enhance the efficiency of the method. The method includes one or more steps for using the kit.

### BACKGROUND OF THE INVENTION

1. Field of the Invention

The present invention relates to kits and methods for assessing, labeling, understanding and directing thoughts. More particularly, the present invention relates to kits and methods for assessing the thoughts of a child and helping the child to label, understand and direct his/her thoughts. Still more particularly, the present invention relates to kits and methods for teaching a child positive thinking skills, including helping the child to develop the ability to become aware of how he/she is thinking, helping the child to identify the his/her negative thoughts and to change those negative thoughts to positive or coping thoughts, and helping the child to stop thinking negative thoughts and to increase thinking positive thoughts, promote positive self-esteem and feelings of efficacy in the child, and build skills of emotional resilience in the child by teaching the child that how he/she thinks can affect how he/she feels.

2. Description of the Prior Art

The brain is structured to process felt sensations registered as either positive or negative. One part of the brain is responsible for the production and processing of positive emotions, while another part is responsible for the production and processing of negative emotions. Felt well-being involves both the production of ample positive emotions and the efficient processing of negative emotions. Individuals who maintain a positive balance to their emotions are more likely to experience emotional well-being and achieve success.

Researchers speak about the neurobiological systems of fetuses and babies as being regulated or dysregulated, or, in other words, in harmony or in distress. Maintaining a positive balance to one's emotions can be automatic, as may manifest in babies with easy temperaments, for example. For some, therefore, a positive balance to their emotional life is hard-wired. The development of positive thinking skills, including awareness of self talk, use of self talk, thought-stopping negative thoughts, recognizing self-defeating or irrational thinking and replacing it with positive thoughts or coping self talk, and practice of regular use of positive thinking skills and self-thought check ups, involves both the creation of positive thoughts and the effective processing of negative emotions (e.g., one such developmental strategy for achieving these skills is to substitute positive thoughts for negative thoughts). To accomplish this goal, both positive and negative thoughts must be accurately recognized and labeled.

While debate among psychological theorists historically has argued for the primacy of either feeling or thought, more recent work by cognitive behavioral theorists has simply explicated the ramifications of the observation that how one thinks about an experience can determine how he/she feels about that experience. The cognitive-behavioral approach stands alongside both the therapeutic approach that has emphasized the identification and processing of emotional experience as the therapeutic agent of change for emotional difficulty and healthy development, and the therapeutic approach that has emphasized the therapeutic relationship as the agent of change. Clinical trials involving individuals suffering from depression have shown that teaching people how to recognize and reframe negative thinking and build positive thinking skills can be an extremely effective treatment for their depression. Brain research has repeatedly shown that without such cognitive intervention, negative thinking becomes self-fulfilling, and perpetuates even more negative thinking and associated negative emotions (For example, see the book “Helplessness: On depression, development, and death” by Martin Seligman, W.H. Freeman Publishing, San Francisco, Calif., 1975.)

Children experience their first feelings as sensorimotor events. That is, something feels good or it feels bad. Researchers have demonstrated that infants can discriminate between various emotional states like happiness, excitement, sadness, anger, and fear, and do so within the context of their earliest attachments. (For example, see the book “The Interpersonal World of the Infant: A View from Psychoanalysis and Developmental Psychology” by Daniel Stern, Basic Books, Inc., New York, N.Y., 1985.) Researchers also have identified the right brain as the part of the brain responsible for organizing the child's emotional/subjective experience of him or her “self,” and self-esteem in infants is assessed through the child's presentation of healthy emotional attachments, curiosity and the achievement of age-appropriate developmental milestones. Between 18 and 36 months, toddlers increasingly use spoken language to communicate their experiences. By age 3, the left brain is directing and organizing the child's experience of himself/herself and the world and is doing so by using linear, logical-sequential thought, which is most remarkably apparent in the child's increased ability to reason, remember and talk. It is at these ages that the child begins to establish a “narrative self,” that is a made and remembered personal history that is created with language rather than by the felt experience of the body itself. It thus becomes possible at this stage for parents and caretakers to teach children specific language to label and respond to their felt experiences in a positive or negative manner that in turn themselves impact the child's evaluation of their felt experience.

A child's mastery and use of positive thinking skills at this time has been shown to be associated with emotional resilience as expressed through stress resistance, positive self-esteem and success. While there is no question that instruction for children concerning these specific thinking skills could be helpful to those amongst them who have already experienced either emotional difficulties or trauma, the possibility of providing instruction to all children as part of a wellness initiative is tremendously appealing. Conceptually, such an initiative involves a huge paradigm shift: from merely preventing mental illness to promoting emotional health.

Existing devices for helping children develop skills for managing their emotional health focus either on a single emotional experience or on teaching children labels to define and contain a particular emotion. For example, consider U.S. Pat. No. 4,573,927 issued to Newman. The Newman patent describes a means and method for expressing feelings. The Newman device is a doll-like figure having changeable facial expressions. The facial expressions are meant to be changed by a child. In this arrangement, the facial expressions are apparently to be chosen by the child to represent the child's feelings.

In a second example, U.S. Pat. No. 5,092,778 issued to Shaver et al. describes an apparatus for diagnosing and treating psychological trauma. The Shaver device is a doll which contains a plurality of objects which are representative of either the nature or intensity of a child's emotional feelings. The plurality of objects of the Shaver doll apparently are meant to be associated with a child's feelings.

In a third example, U.S. Pat. No. 5,405,266 issued to Frank et al. describes a therapy method and doll for carrying out the method. The Frank doll contains a plurality of movable and changeable items which may be used to represent a child's feelings.

In a fourth example, U.S. Pat. No. 6,994,555 issued to Weiner et al. describes a play cube for recognizing and developing various emotional states. Apparently, the Weiner play cube is intended to be used a teaching tool to help a child distinguish between various emotional states.

Since cognitive behavioral theory suggests that teaching positive thinking skills in response to emotional experiences can offer children a fundamental, competence enhancing strategy for adaptation, well-being and success, and no existing device is aimed at accomplishing that long-range goal, what is needed is a kit and method that are directed at meeting that goal. Therefore, specifically what is needed is a kit and method that direct a child's attention to his/her thinking processes so that positive thinking skills can be taught to the child. The kit and method that is needed also should be sufficient for teaching a child that how he/she thinks about a particular event, either positive or negative, affects his/her emotional experience of that event. Further, what is needed is a kit and method which combine educational instruction for developing positive thinking skills and interactive play, the medium through which children learn best.

### SUMMARY OF THE INVENTION

It is an object of the present invention to provide a kit and method for identifying the thoughts of a child, and teaching the child to label, understand and direct his/her thoughts. It is another object of the present invention to provide a kit and method for teaching a child to identify, label and direct his/her thoughts for the purpose of teaching the child about the relationship between thinking and feeling and that his/her thoughts, positive or negative, directly shape the nature of his/her felt emotional experience. It is yet another object of the present invention to provide a kit and method for identifying negative thoughts of a child, teaching a child to develop the ability to become aware of how he/she is thinking, helping a child to stop thinking negative thoughts and to increase thinking positive or coping thoughts, teaching a child positive thinking skills that will last throughout the child's lifetime, promoting positive self esteem and feelings of efficacy in a child and teaching a child strategies that promote positive self-esteem, and building skills of emotional resilience in a child.

The kit of the present invention is used to carry out the method of the present invention. The kit includes several devices which may be used for this purpose. The kit specifically includes thought assessment devices, thought remedying devices, and supporting devices. The thought assessment devices are used to aid in assessing the thoughts of the child who is subject to the method, and the thought remedying devices are used to improve the mental welfare of the child. The supporting devices are used for a variety of purposes, including as a comfort to the child.

The method of the present invention involves using one or more of the thought assessment devices to determine the mental standing of a child subject to the method. The method further involves using one or more of the thought remedying devices to replace any negative thoughts that the child is having with positive thoughts. The remedying devices are also used to teach the child how to think positively, with a goal being that the positive thinking skills, once incorporated into the information processing wiring of the child's brain, thus are learned, will serve the child throughout his/her lifetime. The method may also involve use of one or more supporting devices, such as a plush toy, to improve the child's comfort with both the method and the individual conducting the method to make the method work more efficiently. For example, the plush toy may be used to interact with the child for the purpose of externalizing the child's brain for the child and increasing the likelihood that the child will have a positive relationship with himself/herself.

The details of one or more examples related to the invention are set forth in the accompanying drawings and the description below. Other features, objects, and advantages of the invention will be apparent from the following description and accompanying drawings, and the appended claims.

### BRIEF DESCRIPTION OF THE DRAWINGS

FIG. 1 is a perspective view of a kit of the present invention.

FIG. 2A is a first side view of a dual-cylinder device of the kit of the present invention, showing an inner cylinder of the dual-cylinder device removed from an outer cylinder of the dual-cylinder device.

FIG. 2B is a second side view of the dual-cylinder device of the kit of the present invention, wherein the inner cylinder is contained within the outer cylinder.

FIG. 3A is a front view of a dual-wheel device of the kit of the present invention, showing a first wheel and a second wheel connected to the first wheel.

FIG. 3B is a front view of the first wheel of the dual-wheel device of the kit of the present invention.

FIG. 4 is a side view of a back of a cap having a gauge of the kit of the present invention.

FIG. 5 is a side view of a side of the cap having a gauge of the kit of the present invention.

FIG. 6 is a perspective view of a stethoscope-like device of the kit of the present invention.

FIG. 7A is a front view of a first example of a handheld electronic device of the kit of the present invention.

FIG. 7B is a front view of a second example of the handheld electronic device of the kit of the present invention.

FIG. 8 is a side view of a microphone-like device of the kit of the present invention.

FIG. 9 is a side view of a toy medical viewing device of the kit of the present invention.

FIG. 10 is a front view of a specific embodiment of a bandage of the present invention.

FIG. 11 is a side view of a toy syringe of the kit of the present invention.

FIG. 12 is a perspective view of a spoon of the kit of the present invention.

FIG. 13A is a perspective view of a first embodiment of a pair of eyeglasses of the kit of the present invention.

FIG. 13B is a perspective view of a second embodiment of the pair of eyeglasses of the kit of the present invention.

FIG. 14 is a perspective view of a bracelet of the kit of the present invention.

FIG. 15 is a front view of a container of the kit of the present invention.

FIG. 16A is a front view of a plush toy of the kit of the present invention.

FIG. 16B is a front view of a specific embodiment of the plush toy of the kit of the present invention.

FIG. 17A is a front view of a clipboard of the kit of the present invention, including a notepad.

FIG. 17B is a front view of a specific embodiment of the notepad of the clipboard of the present invention.

### DETAILED DESCRIPTION OF THE PREFERRED EMBODIMENT

A kit and a method of the present invention are designed to be used to teach a child positive thinking skills, including identifying and helping the child to identify the child's negative thoughts, promote positive self esteem and feelings of efficacy in a child, and building skills of emotional resilience in a child by teaching the child that by thinking positively, he/she can create and promote feelings of well-being and decrease experiences of negative emotion. Although the kit and method are specifically aimed at achieving these goals with a child as the subject, it is to be understood that the kit and method are not limited to being used with a child, but may be used to achieve these goals with a subject of any age. For example, the kit and method may be used with an adult subject having a child's emotional capacity, such as may be characteristic of an adult who is autistic, inflicted with Down Syndrome, or has some other cognitive disability.

The kit of the present invention includes one or more devices which may be used to carry out the method of the invention. While in most cases these devices are toy representations of a particular existing object, e.g., an over-sized plastic syringe having a blunt “needle” which cannot penetrate skin, the device need not be in the form of a toy. For example, a medical syringe which is capable of being used with a skin-penetrating needle in the routine care of a patient by a medical professional, but which, for safety reasons, does not actually contain such a needle, may be included as part of the kit of the invention. As another example, the kit may include a sphygmomanometer which actually may be used to measure blood pressure, or may include a toy sphygmomanometer which cannot be used to measure blood pressure.

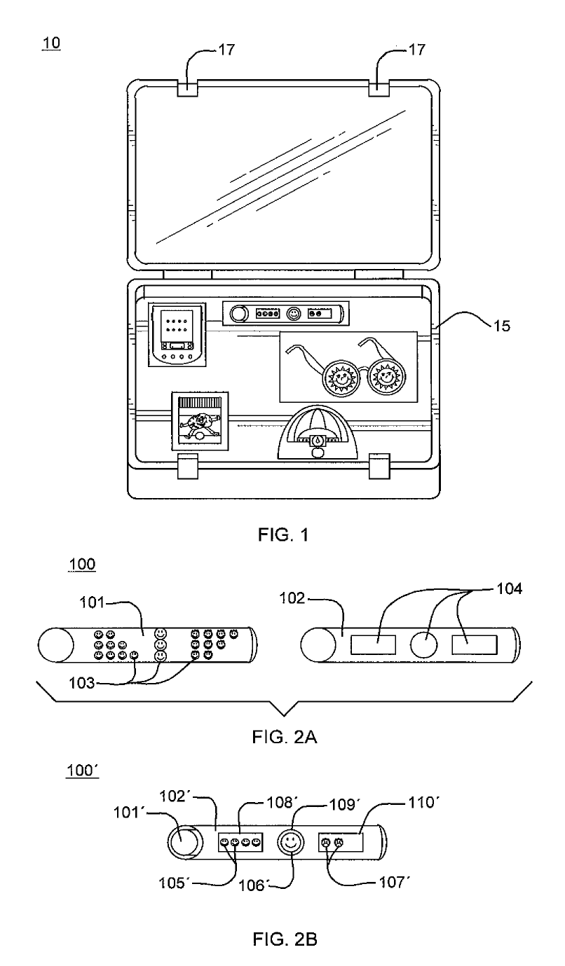

As shown in FIG. 1, the kit 10 may include a carrying case 15 for holding devices of the kit 10. For example, the carrying case may be a solid and ruggedly built container, such as one made of hard plastic. Further, the case may include one or more clips 17 for keeping the case closed. The kit 10 also includes one or more thought assessment devices that may be used to identify the thoughts of a child subject, one or more thought remedying devices that may be used to teach the child positive thinking skills, promote positive self esteem and feelings of efficacy in the child, and/or positively influence the child's mental health, and one or more supporting devices which may be used, for example, to make a child more able and/or willing to participate in the method of the present invention. The thought assessment device and/or the thought remedying device may be used either singly or in combination to identify a child's thoughts, teaching the child positive thinking skills, promote positive self esteem and feelings of efficacy in the child, and building skills of emotional resilience in a child by teaching him/her that how he/she thinks can affect how he/she feels.

Specifically, the thought assessment device may be used to elicit responses from the child regarding his/her thoughts. As shown in FIGS. 2A and 2B, a first example thought assessment device is a dual-cylindrical device 100 including a first cylinder 101 movably contained within a second cylinder 102. Further, the first cylinder 101 may contain one or more icons 103 and the second cylinder may contain one or more display windows 104 through which the icon or icons 103 may be viewed.

In a specific embodiment of the dual-cylindrical device 100′, which is shown in FIG. 2B, the first cylinder 101′ includes three sets of icons: positive icons 105′, expressive icons 106′, and negative icons 107′. The second cylinder includes three display windows: a first display window 108′, a second display window 109′, and a third display window 110′, through which the icons 105′/106′/107′ may be viewed. In this arrangement, sets of positive icons 105′ are aligned in a specific manner with particular sets of both expressive icons 106′ and negative icons 107′. Therefore, when a particular set of positive icons 105′, such as four “smiling faces,” is made to appear in the first display window 108′, a particular number of negative icons 107′, such as two “storm clouds,” will appear in the third display window 110′, and a particular expressive icon 106′, such as a “happy face,” will appear in the second display window 109′.

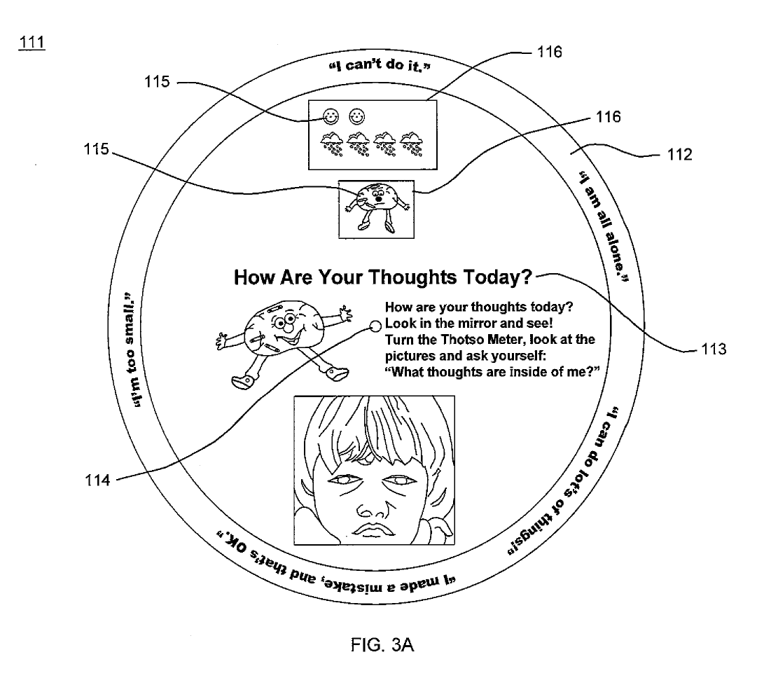

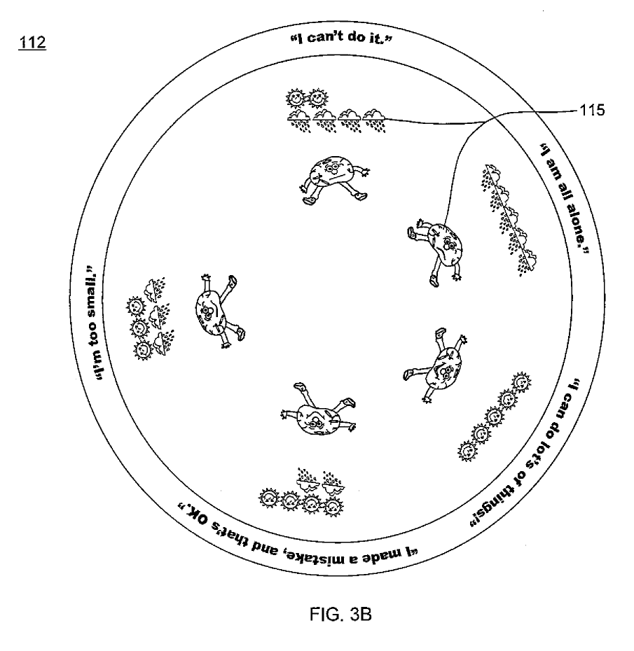

A second example thought assessment device is a dual-wheel device 111, which is shown in FIG. 3A. The dual-wheel device 111 includes a first wheel 112, which is shown alone in FIG. 3B, and a second wheel 113, which is connected to the first wheel 112 at a central axis 114. The second wheel 113 has a smaller circumference than does the first wheel 112. The second wheel 113 may be rotated fully about first wheel 112 about central axis 114. The first wheel 112 and the second wheel 113 may contain one or more icons 115, and the second wheel 113 may contain one or more windows 116 through which the icons 115 may be viewed.

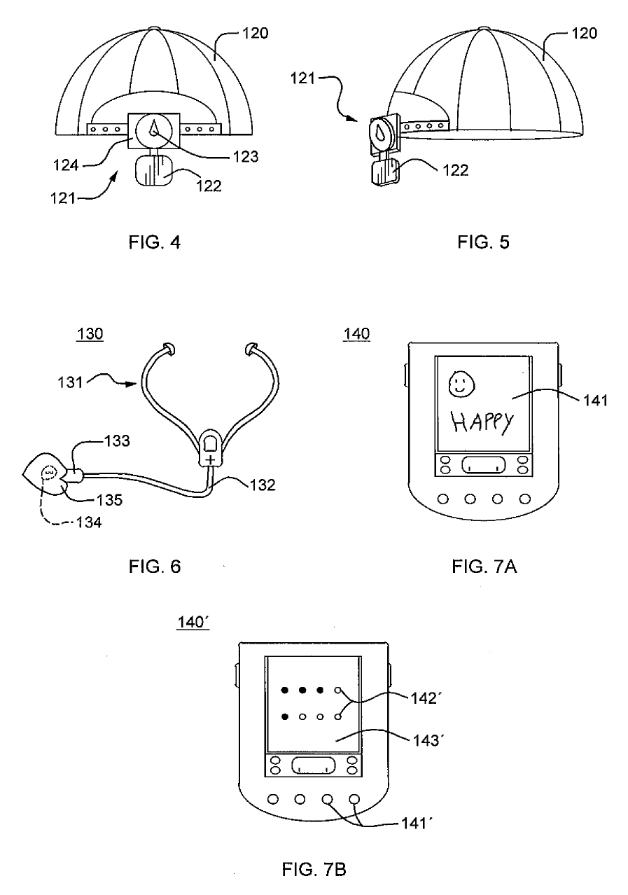

A third example thought assessment device is a cap 120 with an attached toy measuring gauge 121. For example, as shown in FIGS. 4 and 5, the cap 120 may be similar to a baseball cap. The toy measuring gauge 121 may include, for example, a bulb 122, which, when squeezed, causes an indicator 123 to move within a gauge display 124. Further, the measuring gauge 121 may be in the form of a toy sphygmomanometer. The cap 120 is placeable onto a child's head. When the cap 120 is placed on a child's head, the bulb 122 may be squeezed to effect movement of the gauge indicator 123. In this arrangement, movement of the indicator 123 simulates a “reading” of the child's mental condition, which the child may be told is the “amount of boo boo thoughts” that are being put on his/her brain.

A fourth example thought assessment device is a toy stethoscope-like device 130 shown in FIG. 6. When the thought assessment device is in the form of a toy stethoscope-like device, it may be similar in appearance to one which a physician would use to listen to a patient's heartbeat. The toy stethoscope-like device 130 may further include an audio playing device and an activating device for activating the audio playing device. The audio playing device further may be programmed to play a variety of audio clips whenever the activating device is activated. These audio clips may include any sound.

The embodiment of the toy stethoscope-like device 130, shown in FIG. 6, includes a binaural assembly 131, tubing 132 connected to the binaural assembly 131, and a chestpiece 133 connected to the tubing 132. The stethoscope-like device 130 further includes an audio playing device 134 within the chestpiece 133 and an activating device 135, which is a depressible bulb in the form of a heart, for activating the audio playing device 134. The audio playing device 134 is programmed to transmit a variety of sounds, including a human's heartbeat, fast, medium, or slow.

A fifth example thought assessment device is a handheld electronic device 140, as shown in FIGS. 7A-7B. The handheld electronic device 140 of FIG. 7A may be a personal digital assistant (PDA), which may be a toy device 140, as shown in a first example in FIG. 7A, or it may be a working device 140′, as shown in FIG. 7B. The handheld electronic device 140 of FIG. 7A may also include an erasable writing surface 141 on which a person may create words or pictures. The handheld electronic device 140′ of FIG. 7B includes several buttons 141′. When one of the buttons 141′ is pushed, one or more icons 142′ appear on the screen 143′ of the device 140′. The icons 142′, for example, may appear as red or yellow dots. In another example, the icons 142′ may be one or more images of a human brain. Where the icons 142′ are more than one brain image, the icons 142′ may be, for example, a first brain image, a second brain image, and a third brain image, with only one of these images appearing on the screen 143′ at any given time. Each of the first, second and third brain images may include one or more “smiling face” or “bandage” images shown as being on the surface of the brain. In this arrangement, the first brain image may include, for example, more “smiling faces” than “bandages.” The second brain image may include, for example, more “bandages” than “smiling faces.” The third brain image may include, for example, an equal number of “smiling faces” and “bandages.”

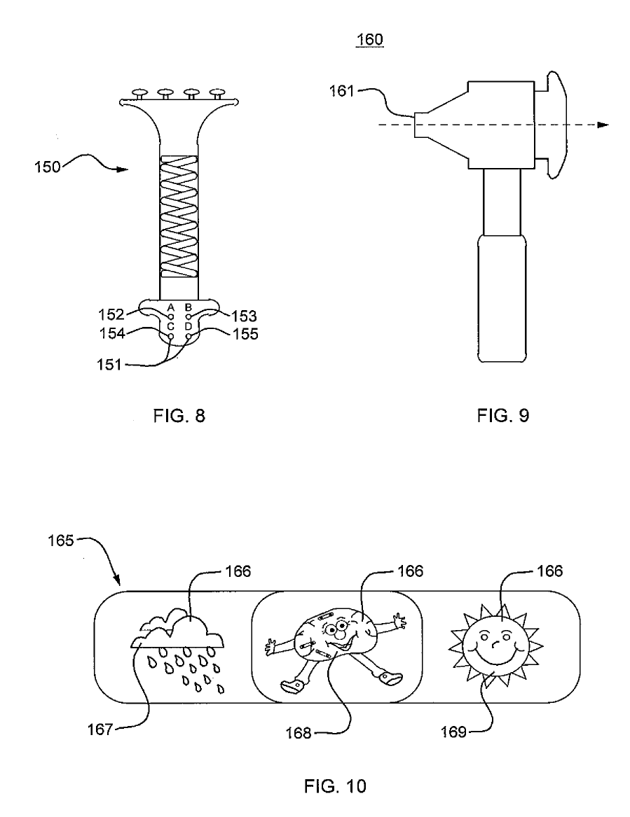

A sixth example thought assessment device is a device which records and/or plays audio clips. For example, the fifth example thought assessment device may be a microphone-like device 150 having one or more buttons 151, as shown in FIG. 8. When one of the buttons 151 of the microphone-like device 150 is depressed, an audio clip may be transmitted from the microphone-like device 150. In the embodiment of the device 150 shown in FIG. 8, it includes four buttons 151: A 152, B 153, C 154, and D 155. When button A 151 is depressed, the microphone-like device transmits the open-ended statement, “I am . . . ”. When button B 153 is depressed, the microphone-like device transmits the open-ended statement, “I feel . . . ”. When button C 154 is depressed, the microphone-like device transmits the open-ended statement, “I can . . . ”. When button D 155 is depressed, the microphone-like device transmits the open-ended statement, “Tomorrow I will . . . ”.

A seventh example thought assessment device is a toy medical viewing instrument. For example, as shown in FIG. 9, the medical viewing instrument is a toy ophthalmoscope 160 including a viewing port 161 through which light may pass, and therefore through which images outside the ophthalmoscope 160 may be observed.

The kit 10 may include one or more of the following: the dual-cylindrical device 100, the cap 120 with an attached toy measuring gauge 121, the stethoscope-like device 130, the handheld electronic device 140, the device which records and/or plays audio clips 150, and/or the toy medical viewing instrument 160. Further, the kit 10 may include other thought assessment devices.

In addition to one or more thought assessment devices, the kit 10 includes one or more thought remedying devices. A first example thought remedying device is shown in a specific representation in FIG. 10 as a bandage 165 having one or more icons 166. The bandage 165 of FIG. 10 includes icons 166 that represent images of a cloud 167, a brain character 168, and a sun 169. It is to be understood, however, that the bandage 165 is not limited to this specific representation.

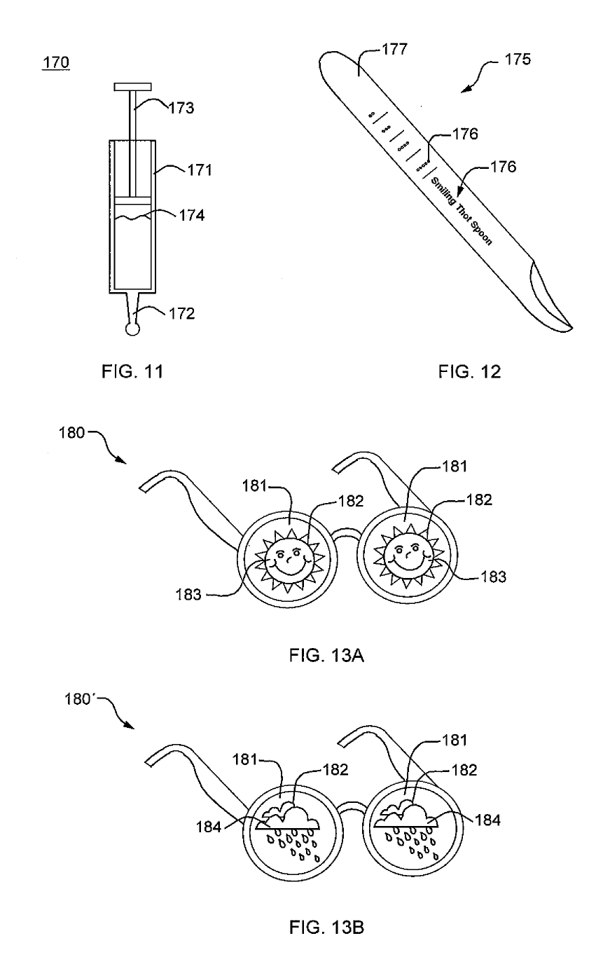

A second example thought remedying device is a toy syringe 170, such as the toy syringe 170 shown in FIG. 11, having a barrel 171 connected to a blunted shaft 172, and a depressible plunging device 173 contained within the barrel 171. Further, the syringe 170 may be designed to appear to contain a liquid 174, such as a liquid medicine, within the barrel 171. When the liquid 174 is included, the liquid 174 may drain from the barrel 171 into the shaft 172, such as to create the illusion that it is leaving the syringe 170, whenever the plunging device 173 is pressed into the barrel 171.

A third example thought remedying device is a spoon, such as an ice cream scoop, or a medicine spoon, such as the medicine spoon 175 shown in FIG. 12. The spoon 175 may contain one or more icons 176, and the icons 176 may be anywhere on the spoon 175. The icons 176 may be images, such as the image of a brain including human arms and legs or the image of a “smiling face,” or the icons 176 may be words or phrases, such as the phrase “A Dose of Happy Thots!” In a preferred embodiment of the present invention, the words or phrases are on the handle portion 177 of the spoon 175, and the image of a brain including human arms and legs is on the bowl region of the spoon 175. Also, in the preferred embodiment of the present invention, the spoon 175 is hollow such that a liquid is containable in the handle portion 177 of the spoon 175.

As shown in FIG. 13A, a fourth example thought remedying device is a pair of eyeglasses 180. The eyeglasses 180 include two eye pieces 181,each including one or more icons 182. A first representation of the eyeglasses 180 in FIG. 13A includes an image of a sun 183 as the icon 182. In FIG. 13B, a second representation of the eyeglasses 180′ includes an image of a cloud 184 as the icon 182.

While the eyeglasses 180/180′ of FIGS. 13A and 13B are shown as having two eye pieces 181 which are separate from each other, it is to be understood that the eyeglasses 180 may have two or more eye pieces 181 that are overlaid with one another and that are separable from each other. They may either be removable adhered to the frame of the eyeglasses or they may be hingedly connected to the frame. For example, an eye piece 181 having a cloud image 184 may be overlaid and liftable from an eye piece 181 having a sun image 183. In this arrangement, the wearer of the eyeglasses may observe, for example, both a sun image 183 and a cloud image 184 when the eye piece 181 having the cloud image 184 is overlaid over the eye piece 181 having the sun image 183, and may observe, for example, only the sun image 183 when the eye piece 181 having the cloud image 184 is lifted away from the eye piece 181 having the sun image 183.

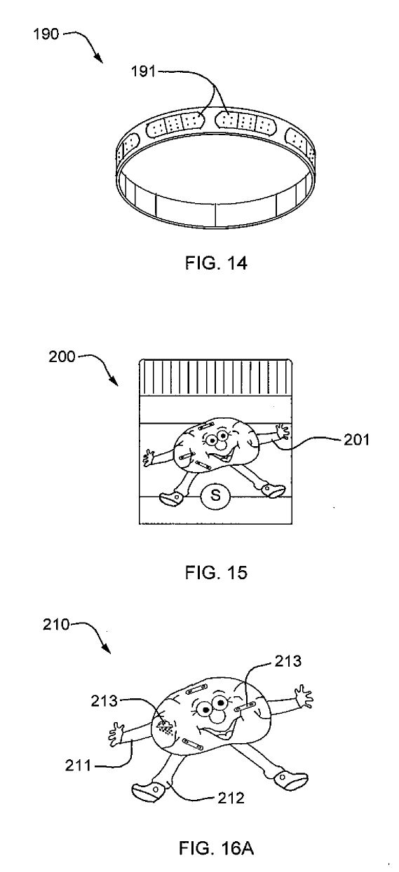

A fifth example thought remedying device is a bracelet 190 shown in FIG. 14. The bracelet 190 may include one or more icons 191. For example, the bracelet 190 may include the image of a bandage or a plurality of images of a bandage. As another example, on a single bracelet 190, the icons 191 may be an image of a storm cloud and/or a bandage, an image of a brain, and an image of a smiling face.

A sixth example thought remedying device is a container, such as the container 200 in the shape of a medicine bottle shown in FIG. 15. The container 200 may include one or more icons 201 and may contain edible goods, such as candy or chewable vitamins.

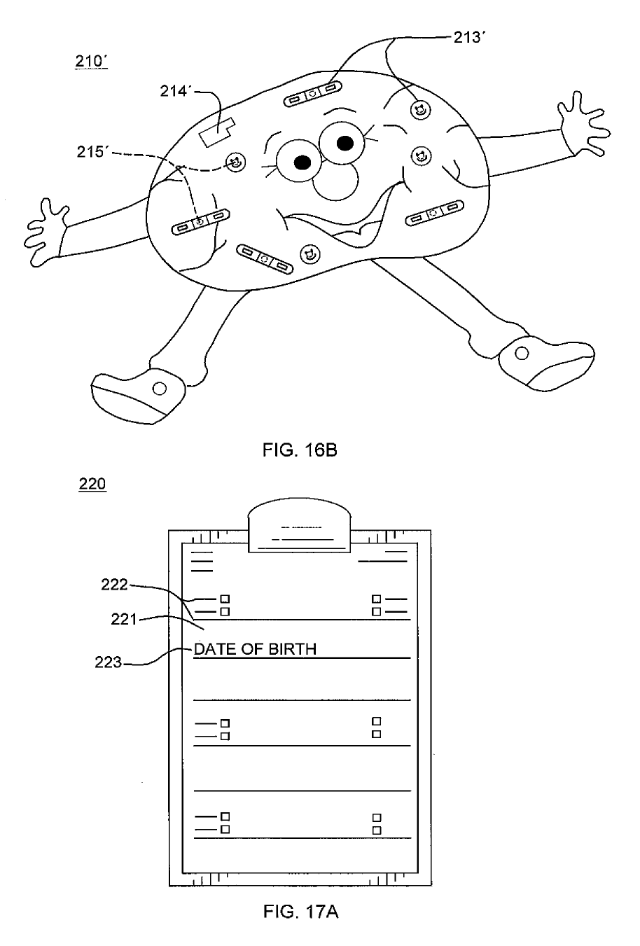

A seventh example thought remedying device is shown in FIG. 16A as a plush toy 210 in the form of a human brain. The brain plush toy 210 includes human-like arms 211 and legs 212, and also includes one or more icons 213. In a specific embodiment, shown in FIG. 16B, the plush toy 210′ includes four “smiling face” icons 213′ and four “bandage” icons 213′. The four “smiling face” icons 213′ cover four buttons 215′ such that each “smiling face” icon 213′ covers its own button 215′, and the four “bandage” icons 213′ cover another four buttons 215 such that each “bandage” icon 213′ covers its own button 215′. When any one of the buttons 215′ is pressed, the audio playing device 214′ may transmit an audio clip. The audio clip may state, for example, the phrase “I can't do it” after a button 215′ covered by a “bandage” icon 213′ is pressed. After the “I can't do it” phrase is transmitted, the brain will respond with a second, positive phrase, such as “Yes you can. You just need to practice.”

The kit 10 may include one or more of the following: the bandage 165, the syringe 170, the spoon 175, the pair of eyeglasses 180, the bracelet 190, the container 200, and/or the plush toy 210. Further, the kit 10 may include other thought remedying devices.

In addition to the one or more thought assessment devices and the one or more thought remedying devices, the kit 10 may also include one or more supporting devices. For example, the supporting device may include a plush toy. The form of the plush toy may be selectable. A first example supporting device is the plush toy 210 shown in FIG. 16A.

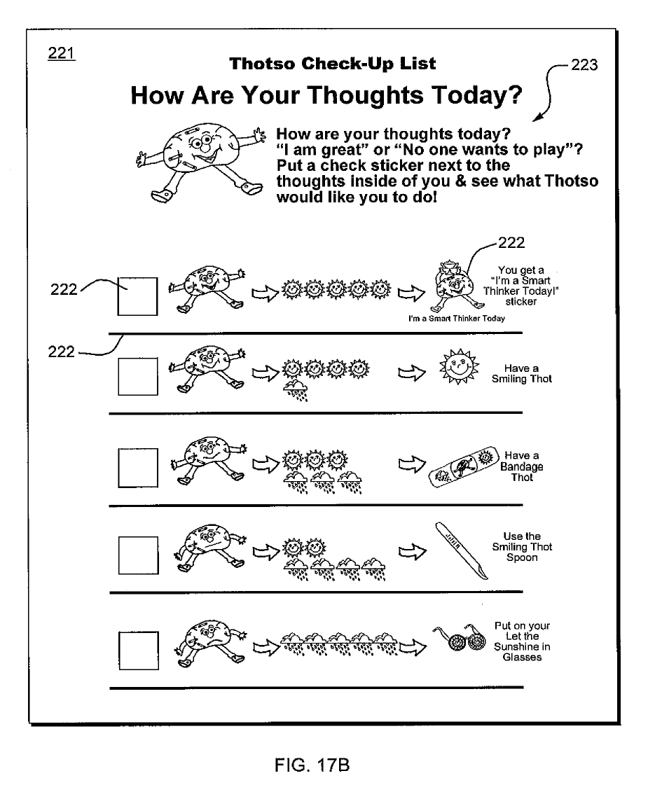

A second example supporting device is a clipboard 220 shown in FIG. 17A. The clipboard 220 includes notepad 221 having permanent, non-erasable icons 222. The icons 222 may be boxes, lines, and/or images. Text 223 may be included, for example, adjacent to or near the boxes and lines. The clipboard 220 may be used, for example, to keep the child subject engaged in an activity as the method is being conducted. A specific example of the notepad 221 of the clipboard 220 of the present invention is shown in FIG. 17B.

The kit may also include information that a user of the kit may wish to consult in carrying out the method. The information may be recorded in written, audio, and/or video form. Further, the information may be brief, such as that which may be contained in a small pamphlet, or it may be very extensive, such as that which may fill several volumes of a treatise or several audio CDs or video DVDs.

The method of the present invention includes one or more steps of using the kit 10. This step or these steps may be followed to identify negative thoughts of a child, teach a child positive thinking skills, promote positive self esteem and feelings of efficacy in a child, and build skills of emotional resilience in a child. The method may be performed by a mental health professional, such as a child psychologist or psychiatrist, social worker, or counselor, or it may be performed by a lay individual, such as a parent who is not formally trained in child psychology, or it even may be performed by a child. If instructions are included with the kit, the mental health professional or lay individual may use the instructions to follow the method, or may choose to use the kit and follow the method in some other manner of his/her own choosing.

Generally, the method involves the steps of: (1) using one or more thought assessment devices to assess the thoughts of a child; and (2) using one or more thought remedying devices to teach the child positive thinking skills, promote positive self esteem and feelings of efficacy in the child, and/or positively increase the child's feelings of well-being and success. Although it is expected that most uses of the method will involve both of these steps, it is to be understood that the method may involve only one of these steps.

Specific examples regarding how the thought assessment device may be used to assess the thoughts of a child subject are as follows. In one example, the dual-cylindrical device 100′ is touched to the child subject's person, such as to the child subject's head, and the person performing the method (the “user”) makes a statement regarding the mental state of the child subject and sets the dual-cylindrical device to reflect the statement accordingly. For example, the user may set the dual-cylindrical device 100′ to show two positive icons 105′, such as “smiling faces,” in first display window 108′, and four negative icons 107′, such as “storm cloud” icons in third display window 110′. Then, the user may touch the dual-cylindrical device 100′ to the child subject's head and say, “My Thotsometer tells me that you have lots of boo boo thoughts and not many smiling thoughts.” Specifically, a comment like this would be made for the purpose of eliciting a response regarding the thoughts of the child from the child. In this “playful” step of the method, the child likely would feel more comfortable discussing his/her thoughts than he/she would otherwise.

In another example of how the thought assessment device may be used to assess a child subject's thoughts, the cap 120 with an attached toy measuring gauge 121 is shown to the child subject while the user explains to the child that the cap 120 and the gauge 121 will measure the pressure at which negative thoughts are being placed on the child's brain. Further, the user explains to the child how the gauge 121 of the cap 120 “works.” The cap 120 is then placed on top of the child subject's head and the bulb 122 of the gauge 121 is squeezed. The user then makes a statement regarding the mental state of the child subject. For example, the user may state that the gauge 121 indicates that the child is “not making many boo boo thoughts” and therefore still has the potential to “make lots of smiling thoughts.” After this statement is conveyed, the child is encouraged to talk about both kinds of thoughts. Statements made by the child subject at that time would provide the user with information regarding the mental state of the child. In another example, the user may state to the child that the gauge 121 indicates that “your boo boo thoughts are not putting much pressure on your brain today. You probably don't have too many.” The user then may state “Perhaps today is a day with mostly smiling thoughts” or ask the child whether the child is “seeing mostly smiling thoughts today.”

The stethoscope-like device 130 may be used in a manner similar to that of the dual-cylinder device 100 and the cap 120 to obtain information regarding a child subject's thoughts. For example, the stethoscope-like device 130 may be worn by the user, while the chestpiece 133 is placed on the head of the child subject. The user may then pretend to listen to the child's brain activity, and squeeze the bulb 135 to transmit a sound or series of sounds from the audio playing device 134, before making a statement regarding the rate at which the child is making thoughts, such as “Your brain is making thoughts very slowly today.” The child might then be asked to make comments regarding the statement which reveal information regarding his/her thoughts, such as by asked the question “What does it feel like for you when your brain is making thoughts very slowly?”

Similarly, the toy medical viewing instrument, such as the toy ophthalmoscope 160 of FIG. 9, may be used to obtain information regarding a child subject's thoughts. For example, the ophthalmoscope 160 may be placed near the child's eyes (or ears), with the eyes (or ears) of the child being viewed through the viewing port 161 by the user. The user may then make a statement, such as “I can see that you are having lots of boo boo thoughts today.” The child may then be asked to state whether he/she agrees with statement, or the child may then be asked to make more detailed comments regarding the statement, for the purpose of eliciting information from the child regarding his/her thoughts.

In another example, the microphone-like device 150 may be used to assess information regarding a child subject's mental state. This would be valuable because the brain learns to make thoughts unconsciously. These thoughts are “automatic thoughts” and they reflect our core feelings of worth. For example, the user may instruct the child subject to depress button B 153 to effectively transmit the recorded statement, “I feel”. The user may then instruct the child to “tell me by speaking into the microphone the first thought your brain makes when it hears the words, ‘I feel’.” In response, the child may state, for example, “yucky,” or “good.” The child may then be further instructed to “tell about” why he/she feels “yucky” or “good.”

In yet another example, the method may involve using the handheld electronic device 140 to assess a child subject's thoughts. In one example of how the handheld electronic device 140 may be used, where the handheld electronic device 140 includes an erasable screen 141, the user may instruct the child subject to draw a picture of himself/herself on the screen 141. The user may then obtain information about the child's thoughts from the picture he/she has drawn. For example, if the child draws a picture of a person having a sad expression, the user might ask the child about his/her negative thoughts. In such a case, why the child drew the particular picture that he/she did could be further explored with the child. Additionally, the handheld device 140′ may be used to assess a child's thoughts. For example, a child subject may be told that the device 140′ will be used to “measure the number of smiling thoughts and boo boo thoughts” the child has. Thereafter, one of the buttons 141′ may be pushed, which effects the display of red and/or yellow icons 142′ on the screen 143′. The child may then be informed that he/she is experiencing a particular number of “smiling thoughts” and a particular number of “boo boo thoughts.” Further, the handheld electronic device 140′ may be used to teach a child that the brain is the location of the words we think. For example, when the handheld electronic device 140′ is programmed to display the first, second, and third brain images as described before, the child could be shown one of these brain images, which include one or more “smiling faces” and/or “bandages,” and instructed by the user that the child's brain is the location of the words he/she thinks, that is, his/her thoughts, by stating this message in a phrase that is understandable to the child. For example, at this time, the user may state to the child that his/her brain is “making lots of smiling thoughts and not many boo boo thoughts,” and then ask the child how those thoughts are making him/her feel.

Specific examples regarding how the thought remedying device may be used to treat a child subject's emotional state are as follows. In one example, the user may attach the bandage 165 and/or touch the syringe 170 to the skin of the child subject, such as that on the arm of the child, while informing the child that the bandage 165 “will heal the boo boo thoughts” or that the syringe 170 contains “smiling thoughts (which are contained in the liquid 174) that will stop the boo boo thoughts.” This may be done, for example, to help the child to reframe the negative thoughts that they are having into positive thoughts. Therefore, when the child is feeling small and weak, applying the bandage 165 and/or syringe 170 to the child may help the child form a positive thoughts, such as “I may be small, but I can do a lot of ‘big’ things like run, jump, and sing.”

Similarly, in another example, a child subject may be shown the spoon 175, which is empty but which contains one or more “smiling face” icons 176 on its surface, and informed that the spoon 175 contains “smiling thoughts for stopping the boo boo thoughts,” or some similar statement. Thereafter, the user may place the spoon to the child's mouth and simulate pouring the “smiling thoughts” into the child's mouth, and in doing so, instruct the child that the “smiling thoughts” will help outnumber the “boo boo thoughts” in his/her brain, and thereby help the child to feel better. The user may then discuss with the child his/her thoughts, and in doing so, promote the child's understanding and frequency of use of positive thoughts. Alternatively or additionally, the user may present the container 200 to the child and inform the child that the container holds “smiling thoughts that, when used, help outnumber the boo boo thoughts,” or some other similar statement. When the container 200 is empty, the user may pretend to administer a dose of “smiling thoughts” from the container 200 to the child. When the container 200 contains an edible good, such as a vitamin, the child may be given the vitamin and instructed that the vitamin contains “smiling thoughts for stopping the boo boo thoughts.”

Similarly, in yet another example, the bracelet 190 having images 191 of bandages may be used to raise the child's awareness of how he/she is thinking, such as for the purpose of teaching the child subject that he/she has the ability to control his/her own thoughts and to manage his/her emotional response to those thoughts. For example, if in response to the use of a thought assessment device, the child indicates that he/she “has lots of boo boo thoughts,” the user may place the bracelet 190 around the wrist of the child and instruct the child that the child can snap the bracelet 190 “when the boo boo thoughts come” to “remind his/her brain to make positive thoughts to replace boo boo thoughts.” In one specific example, a child who has spoken the phrase “I can't do it” when asked whether he/she has learned to ride a bike, may be given the bracelet 190 and instructed to put it around his/her wrist. Further, the child may then be asked to snap the bracelet 190 as described to create an opportunity for the child to form a positive thought, such as “I'm only just learning to ride my bike,” “It takes practice to learn how to ride a bike,” and “I'm sure that with enough practice I will be able to ride my bike soon,” to replace a negative thought.

In another example, the eyeglasses 180′ shown in FIG. 13 and described before may be used to help a child who is subject to the method. For example, these eyeglasses 180′, which contain a first transparent substrate 184′ having an image of a cloud 185′ and a second transparent substrate 186′ having an image of a sun 187′, may be used to teach a child subject that it is the child who controls whether he/she maintains a favorable or disfavorable outlook. To achieve this goal, the eyeglasses 180′ may be placed onto the face of the child such that both the cloud and sun images 185′/187′ appear over one of the eyes of the child. While the user repeatedly lifts the cloud image 185′ from the sun image 187′, the child may then be told that it is he/she who makes the decision to see “negative/cloudy” or “positive/sunny.”

In another example, a child may be encouraged to interact with the plush toy 210 for the purpose of externalizing the child's brain for the child. In this step of the method, the form and appearance of the plush toy 210 specifically promotes the experience of the child having a positive relationship with himself/herself.

In yet another example, the clipboard 220 may be used by the child subject to record information obtained from the method of the present invention, such as “results” generated by using the dual-cylindrical device 100, for example. Upon recording these “results,” icons 222 and/or text 223 on the clipboard 220 may instruct the child subject to perform a particular task or tasks, such as to pour “smiling thoughts” into his/her mouth by using the medicine spoon 175, for example.

Further, the method of the present invention may involve one or more steps which do not involve use of either the thought assessment device or the thought remedying device. For example, in one step, a supporting device, such as the plush toy 210, may be used for the sole purpose of comforting a distressed child. In such a step, therefore, the plush toy 210 would not be used to directly achieve a goal of the method, such as to assess or remedy thoughts, but instead would indirectly facilitate the goal by making the child more able and/or willing to participate in the method.

While the present invention has been described with particular reference to certain embodiments of the kit and method of the present invention, it is to be understood that the invention includes all reasonable equivalents thereof as defined by the following appended claims.

What is claimed is:

1. A kit for teaching strategies that promote positive self-esteem in a person, the kit comprising one or more devices which either singly or in combination aid in teaching the person positive thinking skills, including helping the person to develop the ability to become aware of how the person is thinking, helping the person to identify the person's negative thoughts and to change those negative thoughts to positive or coping thoughts, and helping the person to stop thinking negative thoughts and to increase thinking positive thoughts, promote positive self-esteem and feelings of efficacy in the person, and build skills of emotional resilience in the person by teaching the person that how the person thinks can affect how the person feels, wherein the one or more thought assessment devices may be used to elicit responses from the person regarding the person's thoughts.

2. The kit of claim 1 wherein the kit includes one or more thought assessment devices.

3. The kit of claim 2 wherein the one or more thought assessment devices are selected from the group consisting of:
a. a dual-cylindrical device, wherein an inner cylinder of the dual-cylinder device is contained within an outer cylinder of the dual-cylinder device, and the inner cylinder includes one or more icons and the outer cylinder has one or more windows through which the one or more icons may be viewed;
b. a dual-disc device including a first disc and a second disc, wherein the second disc of the dual-disc device is connectable to the first wheel of the dual-disc device, and the first wheel and second wheel include one or more icons and the second wheel has one or more windows through which the one or more icons of the first wheel may be viewed;
c. a cap for a human head, wherein the cap includes a toy measuring device;
d. a toy stethoscope;
e. a toy handheld electronic device;
f. a toy medical viewing instrument; and
g. a device which is capable of recording and/or transmitting one or more audio clips.

4. The kit of claim 3 wherein the toy stethoscope is capable of transmitting one or more audio messages.

5. The kit of claim 3 wherein the toy handheld electronic device contains an erasable screen capable of displaying text and images.

6. The kit of claim 3 wherein the toy medical viewing instrument is an ophthalmoscope.

7. The kit of claim 3 wherein the device which is capable of recording and/or playing audio clips is in the form of a microphone.

8. The kit of claim 2 further comprising one or more thought remedying devices, wherein the thought remedying devices may be used to help the person label, understand, and direct his/her thoughts.

9. The kit of claim 8 wherein the one or more thought remedying devices are selected from the group consisting of:
a. a bandage;
b. a toy syringe;
c. a spoon;
d. eyeglasses, wherein the eyeglasses include one or more transparent substrates and the one or more transparent substrates include one or more images;
e. bracelet;
f. clipboard; and
g. container.

10. The kit of claim 8 further comprising a carrying case, wherein the one or more thought assessment devices and/or the one or more thought remedying devices are containable in the carrying case.

11. The kit of claim 2 wherein the kit further includes one or more supporting devices.

12. The kit of claim 11 wherein one of the one or more supporting devices is a plush toy.

13. The kit of claim 12 wherein the plush toy includes an audio playing device, one or more icons, and one or more buttons, wherein each of the one or more icons covers one button and no more than one icon covers any single button, and wherein pressing any one of the one or more buttons causes an audio clip to be transmitted from the audio playing device.

14. The kit of claim 9 wherein the eyeglasses include two transparent substrates, a first transparent substrate and a second transparent substrate, each of which cover one of two eye ports of the eyeglasses, wherein the first substrate includes an image of a cloud and the second substrate includes an image of the sun, and wherein the first substrate is removable from the second substrate.

15. The kit of claim 9 wherein the container includes an edible item.

16. The kit of claim 2 further comprising a carrying case, wherein the one or more thought assessment devices and/or the one or more thought remedying devices are containable in the carrying case.

17. A method for assessing a person's thoughts, the method comprising the steps of using one or more devices which either singly or in combination aid in:
a. identifying negative thoughts of the person;
b. teaching the person positive thinking skills, including identifying and helping the person to identify the person's negative thoughts and change those negative thoughts to positive thoughts;
c. promoting positive self esteem and feelings of efficacy in the person;
d. building skills of emotional resilience in the person by teaching the person that how the person thinks can affect how the person feels; and
e. using one or more devices to aid in carrying out one or more steps of (a)-(d).

18. The method of claim 17 wherein the one or more devices is one or more thought assessment devices, and the method involves using the one or more thought assessment devices to elicit responses from the person regarding the person's thoughts.

19. The method of claim 17 wherein the one or more devices is one or more thought remedying devices, and the method involves using the one or more thought remedying devices to help the person label, understand, and direct the person's thoughts.

20. The method of claim 17 wherein one or more devices is a supporting device.
